(19) United States
(12) Patent Application Publication
(10) Pub. No.: US 2018/0337510 A1
(43) Pub. Date: Nov. 22, 2018

(54) EXCIMER LASER OSCILLATION DEVICE HAVING GAS RECYCLE FUNCTION

(71) Applicant: L'Air Liquide, Société Anonyme pour l'Etude et l'Exploitation des Procédés Georges Claude, Paris (FR)

(72) Inventors: Terumasa KOURA, Tokyo (JP); Koji MATSUMOTO, Tokyo (JP); Fumikazu NOZAWA, Tokyo (JP); Yusuke SHINOHARA, Tokyo (JP)

(21) Appl. No.: 15/981,992

(22) Filed: May 17, 2018

(30) Foreign Application Priority Data
May 17, 2017 (JP) 2017-98468

(51) Int. Cl. H01S 3/225; G01N 31/22; H01S 3/036; H01S 3/097; H01S 3/134; H01S 3/22

(52) U.S. Cl. CPC H01S 3/225; G01N 31/223; H01S 3/2207; H01S 3/09705; H01S 3/134; H01S 3/036

(57) ABSTRACT

It is an object to provide a removal function of removing impurities from exhaust gas including rare gas (for example, argon, xenon, krypton and the like) that is used in an excimer laser oscillation device, in a system of the excimer laser oscillation device.

The excimer laser oscillation device including a gas recycle function includes an oscillation chamber in which laser gas having halogen gas, rare gas and buffer gas is filled inside, a first impurity removing device that removes impurities in exhaust gas that is discharged from the oscillation chamber, inside the system of the excimer laser oscillation device.

### CROSS REFERENCE TO RELATED APPLICATIONS

This application claims the benefit of priority under 35 U.S.C. § 119 (a) and (b) to Japanese Patent Application No. 2017-98468, filed May 17, 2017, the entire contents of which are incorporated herein by reference.

### TECHNICAL FIELD

The present invention relates to an excimer laser oscillation device that removes impurities from exhaust gas that is discharged from an oscillation chamber of excimer laser, recovers, for example, krypton-containing neon gas, xenon and argon-containing neon gas, and xenon-containing neon gas that are rare gases required by the excimer laser oscillation device, and can reuse the rare gases as recycle gas.

### BACKGROUND ART

A conventional excimer laser oscillation device does not have a recycle function of laser gas (laser medium gas) that is used in the oscillation device, and a recycle system (also referred to as a neon recovery system) that removes impurities from the exhaust gas (used laser gas) that is discharged to outside the system of the excimer laser oscillation device has been required, separately from the oscillation device. In general, a technique in the mainstream is to separate impurities and rare gas in exhaust gas to purify the rare gas as high purity neon gas with neon of 99% or more by using various separation techniques such as low-temperature separation, and to recycle the exhaust gas as raw material gas of the laser gas.

For example, there is cited Patent Literature 1 as an example of a method that removes a fluorine compound in a step of reusing exhaust gas that is discharged to outside a system from an excimer laser oscillation device.

Further, Patent Literature 2 describes a method for recovering neon gas from an excimer laser oscillation device that uses xenon-chlorine gas.

Patent Literature 3 describes a rare gas separating and recovering device that can remove impurities in trace amounts contained in exhaust gas in various processes using krypton and xenon, is installed in the vicinity of an excimer laser oscillation device and separates and recovers, and reuses only rare gas (krypton, xenon).

Further, Patent Literature 4 describes a structure that removes halogen from laser gas (exhaust gas) that is discharged to outside the system from an excimer laser oscillation device, replenishes laser gas components after predetermined purification treatment, and feeds the gas to the excimer laser oscillation device again to reuse the gas.

Further, Patent Literature 5 describes recovering only neon gas with high purity from the exhaust gas of a main component neon gas containing a large amount of impurities that is discharged to outside the system from a KrF excimer laser oscillation device.

Further, as the methods for decomposing CF₄ in the exhaust gas, Patent Literature 6 describes a method of using silent discharge, and Non Patent Literature 1 describes a method by corona discharge.

### CITATION LIST

### Patent Literatures

[Patent Literature 1] Japanese Patent Laid-Open No. 2010-92920
[Patent Literature 2] Japanese Patent Laid-Open No. 2008-168169
[Patent Literature 3] Japanese Patent Laid-Open No. 2004-161503
[Patent Literature 4] Japanese Patent Laid-Open No. 11-54851
[Patent Literature 5] Japanese Patent Laid-Open No. 2001-232134
[Patent Literature 6] Japanese Patent Laid-Open No. 2006-110461

### Non-Patent Literature

[Non Patent Literature 1] T. IEEE Japan, Vol. 117-A, No. 10 (1997) “Removal of gaseous impurities in excimer gas by corona discharge”

### SUMMARY OF INVENTION

### Technical Problem

As disclosed in the above described Background of Art and Patent Literatures 1 to 5, in order to recycle the exhaust gas discharged to outside the system from the excimer laser oscillation device, a purifying device for recycling is additionally needed, and an installation space for the purifying device is necessary. Further, the recycle device and the excimer laser oscillation device are separate devices, so that it is necessary to operate the respective devices in cooperation with each other.

Further, in order to separate impurities from the exhaust gas discharged to outside the system from the excimer laser oscillation device, recover neon gas with purity as high as or substantially equivalent to the neon gas in the laser gas of a raw material, and recycle and use the neon gas as the laser gas, it is necessary to remove rare gas such as argon (Ar) and krypton (Kr) from the exhaust gas. However, as the exhaust gas purification device that separates argon and krypton from the exhaust gas, use of a cryogenic technique at −100° C. or less is cited. Further, as a method that does not use a cryogenic technique, there is proposed a separation method by increasing the pressure of exhaust gas by a booster or the like and an adsorption technique. However, the cryogenic technique, and increasing the pressure of the exhaust gas and the adsorption technique require tremendous energy.

Further, the conventional exhaust gas purification device is large-sized, and is designed to also deal with a large amount of exhaust gas which is discharged from a plurality of excimer laser oscillation devices. It is concerned that when the exhaust gas purification device stops operation, a large influence is exerted on operation of the plurality of excimer laser oscillation devices which are connected to the exhaust gas purification device.

Further, even if argon (Ar) and krypton (Kr) are removable, and recycle gas with neon (Ne) as a main component can be purified, impurities such as CF₄ that are generated in the excimer laser oscillation device have an influence on laser oscillation. Removal of these impurities such as CF₄ is described in the above described Patent Literatures and the like, but is not easy. Further, it is not easy to detect an impurity concentration in the exhaust gas (low-purity neon gas) which is introduced into the exhaust gas purification device. Therefore, when the impurity concentration in the exhaust gas is high, performance of the exhaust gas purification device (in particular, a device such as adsorption and removal means) is lowered earlier. Consequently, a frequency of maintenance such as exchange of adsorbing and removing means increases.

Further, the impurity removing device in Patent Literature 1 has a step of removing impurities including CF₄ by an adsorbent such as zeolite, but has a problem of being unable to remove CF₄ by the adsorbent completely in the case of exhaust gas containing CF₄ at high concentration. Consequently, as for CF₄ generated in the excimer laser oscillation device, the CF₄ concentration in recycle gas gradually increases when the purification step of exhaust gas is repeated, and a trouble is concerned such as reduction in laser pulse output energy in the excimer laser oscillation device. Further, there is a problem of generating oxygen that is a new impurity at the time of CF₄ decomposition, depending on the decomposition method.

Further, the method that decomposes CF₄ in exhaust gas by silent discharge in Patent Literature 6 can decompose CF₄ of a relatively high concentration, but there is the problem that a constant amount of CF₄ also remains after decomposition. The method of decomposing CF₄ in exhaust gas by corona discharge in Non Patent Literature 1 has the problem that the electrodes are easily fluorinated and deteriorated.

A first object of the present invention is to provide a removal function of removing impurities from exhaust gas including rare gas (for example, argon, xenon, and krypton) that is used in the excimer laser oscillation device within a system of the excimer laser oscillation device.

Further, a second object of the present invention is to remove a part of impurities from exhaust gas that is discharged from an oscillation chamber of an excimer laser in a system of an excimer laser oscillation device, and remove the other impurities outside the system of the excimer laser oscillation device.

Further, a third object of the present invention is to measure an impurity concentration in exhaust gas that is discharged from an oscillation chamber of an excimer laser in a system of an excimer laser oscillation device, and perform removal treatment of impurities in the system of the excimer laser oscillation device and/or outside the system of the excimer laser oscillation device.

Further, an object is to recycle and use purified gas (laser gas containing rare gas) from which impurities are removed.

### Solution to Problem

An excimer laser oscillation device including a gas recycle function of the present invention includes

an oscillation chamber in which laser gas having halogen gas (for example, fluorine), rare gas (for example, krypton, argon, and xenon), and buffer gas (for example, neon and chlorine) is filled inside, and

a first impurity removing device that removes impurities in exhaust gas discharged from the oscillation chamber, inside a system of the excimer laser oscillation device.

The first impurity removing device may have a fluorine compound removal section that removes a fluorine compound that is a part of impurities. The first impurity removing device may have only the fluorine compound removal section.

The first impurity removing device may have a decomposing device that decomposes a carbon fluoride (CF₄ or the like) that is a part of the impurities to a decomposition byproduct.

The first impurity removing device may have a decomposition byproduct removal section that causes the decomposition byproduct generated in the decomposing device to react with a predetermined reaction agent and removes the decomposition byproduct from the exhaust gas. The decomposition byproduct at the time of a carbon fluoride being decomposed is, for example, a fluorine compound.

The first impurity removing device may have a decomposing device and a decomposition byproduct removal section without having the fluorine compound removal section.

The first impurity removing device may have an impurity concentration measurement section that measures an impurity concentration in exhaust gas that is discharged from the oscillation chamber. The first impurity removing device may have an impurity concentration measurement section without having the fluorine compound removal section, the decomposing device or the decomposition byproduct removal section.

The impurity concentration measurement section may be set upstream or downstream of the fluorine compound removal section.

The impurity concentration measurement section may be installed upstream of the decomposing device and used in determination of whether or not to remove impurities by the decomposing device. Further, the impurity concentration measurement section may be installed downstream of the decomposing device, and measure the concentration of the impurities after being treated by the decomposing device.

The impurity concentration measurement section may measure a concentration of any one kind or a plurality of kinds of CF₄, N₂ and He as impurities in the exhaust gas.

The first impurity removing device may have a buffer tank for storing exhaust gas upstream and/or downstream of the decomposing device.

The first impurity removing device may have a buffer tank for storing exhaust gas upstream and/or downstream of the decomposition byproduct removal section.

The first impurity removing device may have a buffer tank for storing exhaust gas upstream and/or downstream of the impurity concentration measurement section.

The first impurity removing device may have a buffer tank for storing exhaust gas upstream and/or downstream of the fluorine compound removal section.

In the above described invention, “in the system” refers to a component (including an element protruded from a casing) that is inside a casing and connected to the casing when the excimer laser oscillation device is a single casing, and includes a component that is disposed in contact with these casings or disposed in the vicinity of these casings, when the excimer laser oscillation device is composed of a plurality of casings.

In the present invention, “upstream” and “downstream” means a disposition relationship in a flow direction of gas (exhaust gas, purified gas, recycle gas, raw material laser gas and the like) unless specially noted clearly. The same will apply hereunder.

An external (a single casing) size of the excimer laser oscillation device may be, for example, 2200 to 3500 (W)×500 to 1500 (D)×1500 to 2500 (H).

The excimer laser oscillation device is a kind of gas laser and oscillates light in an ultraviolet range. A high voltage (high-voltage pulse discharge) is applied to excitation gas with at least a pair of electrodes in the oscillation chamber, whereby excimer in an excited state is generated to cause induced emission and light (ultraviolet ray) is obtained.

The light which is emitted from the oscillation chamber may be adjusted to a specific wavelength width by a band narrowing module (a prism, composed by having a grating), for example. The light that is returned to the oscillation chamber from the band narrowing module is amplified by passing between the pair or electrodes. Further, the band narrowing module and the output mirror connect to each other in the optical path line so that light passes through the oscillation chamber, and each time light reciprocates between the band narrowing module and the output mirror, the light passes between the pair of electrodes, whereby the light is amplified. A function of a resonator is realized by the band narrowing module and the output mirror. The light transmitting through the output mirror is outputted to an exposing device, for example, as output laser light.

The laser gas that is filled in the oscillation chamber has, for example, buffer gas (for example, 90 to 95%) such as neon gas, and excitation gas composed of rare gas (Kr, Ar, Xe) (for example, 5 to 9%) and halogen gas (F₂) (for example, 1 to 5%). For example, as the excitation gas, KrF, ArF, XeF, Ar/XeF and the like are cited.

The excimer laser oscillation device may have

one or more laser gas supply lines that supplies one or more laser gas to the oscillation chamber,

the oscillation chamber to which the laser gas is supplied from the laser gas supply line, and

the exhaust gas line for feeding the laser gas (exhaust gas) that is discharged from the oscillation chamber to the first impurity removing device (or the impurity concentration measurement section).

In the exhaust gas line, and the laser gas supply line, the control valve, a gas pressure adjustment section or a gas pressure gauge, and/or a gas flow rate adjustment section or a gas flow meter may be installed.

The excimer laser oscillation device may have a pump for discharge.

The excimer laser oscillation device may have a laser gas pressure gauge that measures a pressure of the laser gas in the oscillation chamber.

In the excimer laser oscillation device, a control valve, a gas pressure adjustment section or a gas pressure gauge, and/or a gas flow rate adjustment section or a gas flow meter may be installed in order to perform supply of a predetermined amount of laser gas at a predetermined pressure to the oscillation chamber, and discharge of a predetermined amount of laser gas from the oscillation chamber, and control may be performed by a laser gas supply/discharge control section.

The gas pressure in the oscillation chamber and a supply pressure (a first pressure) of the laser gas are set in accordance with the specifications of the excimer laser oscillation device, and are usually higher pressures than atmospheric pressure, and for example, in a gauge pressure, a range of 300 KPa to 700 KPa, preferably a range of 400 KPa to 700 KPa, and more preferably a range of 500 KPa to 700 KPa are illustrated.

The pressure of the exhaust gas that is discharged from the oscillation chamber is from the atmospheric pressure to the first pressure inclusive, and for example, a range of 50 KPa to 200 KPa in the gauge pressure is cited.

The pressure of the first purified gas which is increased in pressure to a predetermined pressure by a booster has a larger value than the first pressure, and a difference from the first pressure is in a range of 50 KPa to 150 KPa in the gauge pressure, for example.

The excimer laser oscillation device may have a decomposition removal treatment line for feeding the exhaust gas to the decomposing device and the decomposition byproduct removal section based on the result measured by the impurity concentration measurement section. The decomposition removal treatment line may be connected to the exhaust gas line connected to the oscillation chamber, or may be also used as the exhaust gas line.

The excimer laser oscillation device may have a release line for releasing the exhaust gas to outside the system of the excimer laser oscillation device based on the result measured by the impurity concentration measurement section.

The excimer laser oscillation device may have a bypass line for feeding the exhaust gas to the process at the subsequent stage without feeding the exhaust gas to the decomposing device and the decomposition byproduct removal section based on the result measured by the impurity concentration measurement section.

The excimer laser oscillation device may include a treatment selection section that selects any one of first treatment that discharges exhaust gas to outside air, second treatment that executes impurity removing treatment, and third treatment that feeds the exhaust gas to a process of a subsequent stage, based on a result measured by the impurity concentration measurement section.

When the first treatment is selected in the treatment selection section, the exhaust gas may be released to outside air by the release line,

when the second treatment is selected in the treatment selection section, the exhaust gas may be fed to the decomposing device provided in the decomposition removal treatment line and the decomposition byproduct removal section, and impurities in the exhaust gas may be decomposed and removed, and

when the third treatment is selected in the treatment selection section, the exhaust gas may be fed to the process at the subsequent stage by the bypass line.

A valve control section that controls opening and closing of the valve so as to release the exhaust gas to the release line when the first treatment is selected, feed the exhaust gas to the decomposition removal treatment line when the second treatment is selected, and feed the exhaust gas to the bypass line when the third treatment is selected may be included.

The decomposing device may be, for example, a silent discharge device, or a short wavelength light oscillation device. As a short wavelength light, excimer laser light, UV laser light and the like are cited. The decomposing device may have a decomposition chamber. Exhaust gas is fed to the decomposition chamber from the oscillation chamber, excimer laser light may be emitted in the decomposition chamber to decompose an impurity (CF₄) in the exhaust gas. CF₄ is decomposed to a decomposition byproduct (F₂, other fluorine compounds), and the decomposition byproduct may react with a predetermined reaction agent and may be absorbed and removed in the decomposition byproduct removal section.

In the present invention, the above described “predetermined reaction agent” is, for example, a metal reaction agent, a gas absorbing reaction agent or the like. As the metal reaction agent, for example, reaction agents of Ag and Cu are cited. As the gas absorbing reaction agent, for example, an acid gas absorbing reaction agent is cited, and use of an oxygen-containing substance represented by, for example, soda lime as the reaction agent is cited.

The fluorine compound is SiF₄ and COF₂, for example.

The carbon fluoride is CF₄, for example.

The decomposition removal treatment line may be configured by having piping and an automatic on-off valve, for example.

The bypass line may be configured by having piping and an automatic on-off valve, for example.

The release line may be configured by having, for example, piping, a vent device for discharging to outside air, an automatic on-off valve and the like.

The impurity concentration measurement section may be disposed in piping such as the decomposition removal treatment line, for example, may be disposed in a space where concentration measurement can be performed, or may be disposed in a buffer tank.

In the present invention, the “purified gas” and “recycle gas” are main component neon gas including first rare gas (for example, Ar, Kr), for example.

In the present invention, the impurities in the exhaust gas include any one kind or a plurality of kinds of CF₄, N₂, He, oxygen, and water, for example. Rare gas (for example, argon, krypton, xenon) and buffer gas such as neon are not impurities, unless specially noted clearly as impurities.

In the present invention, in the case of having an impurity concentration measurement section, an impurity (for example, CF₄) concentration in the exhaust gas fed from the oscillation chamber is measured, and various kinds of treatment can be performed to the exhaust gas in accordance with the measurement result.

In the present invention, for example, when the impurity concentration is a higher concentration than a predetermined concentration range (for example, 10 ppm to 120 ppm), the exhaust gas is released to outside air, the impurities are decomposed and removed when the impurity concentration is in a predetermined concentration range (for example, 10 ppm to 120 ppm), and when the impurity concentration is less than a predetermined concentration range (for example, 10 ppm to 120 ppm), the exhaust gas is directly fed to the process at the subsequent stage (process of a second impurity removing device).

That is, in the process at the subsequent stage (the process of the second impurity removing device), only the exhaust gas (also referred to as “the first purified gas”) including impurities which are not removed by the first impurity removing device can be fed, so that in the process at the subsequent stage, removal of the impurities can be further performed.

Further, it becomes possible to suppress a phenomenon in which performance of the decomposition byproduct removal section of the first impurity removing device or the first and the second removal sections of the second impurity removing device are deteriorated early, and to decrease the number of maintenance times.

In the system of the excimer laser oscillation device, the recycle treatment of the exhaust gas (depending on the embodiments, removing treatment of a part of the impurities, removing treatment of all the impurities) can be performed. For example, in the system of an ArF excimer laser oscillation device and a KrF excimer laser oscillation device, the impurities are removed from the exhaust gas, and the main component neon gas containing first rare gas is purified, and can be reused as the recycle gas.

Further, the present invention has the configuration in which rare gas (Ar, Kr) is not removed, so that cryogenic treatment, and high pressure treatment of 1 MPaG or more are not necessary, the device configuration can be made compact, and the device can be incorporated into the system (casing) of the excimer laser oscillation device.

Further, impurities such as CF₄ generated in the oscillation chamber can be efficiently removed, so that laser oscillation performance can be stabilized.

Further, by incorporating the gas recycle function into the excimer laser oscillation device, gas recycle treatment for each excimer laser oscillation device is enabled, and recycle efficiency can be enhanced more than in a large-scale exhaust gas purification device that is connected to a plurality of excimer laser oscillation devices.

Further, by incorporating the gas recycle function into the excimer laser oscillation device, an installation space including the conventional exhaust gas purification device can be saved.

By incorporating the gas recycle function in the excimer laser oscillation device, an operation sequence is simplified more than the exhaust gas purification device connected to a plurality of excimer laser oscillation devices, and reduction in failure rate can be expected.

In the above described invention, when the impurity concentration measurement section measures the concentration of CF₄ in the exhaust gas,

the treatment selection section selects the first treatment when the concentration of CF₄ is a first threshold value or more,

and the treatment selection section selects the second treatment when the concentration of CF₄ is larger than a second threshold value that is smaller than the first threshold value, and is less than the first threshold value, and

when the concentration of CF₄ is less than the second threshold value, the treatment selection section may perform control of selecting the third treatment.

In the above described invention, “the first threshold value” is an arbitrary numerical value between 80 ppm and 110 ppm, for example, preferably an arbitrary numerical value between 90 ppm and 100 ppm, and more preferably 100 ppm.

In the above described invention, “the second threshold value” is, for example, an arbitrary numerical value between 5 ppm and 15 ppm, preferably an arbitrary numerical value between 8 ppm and 12 ppm, and more preferably 10 ppm.

In the present invention, the concentration means a volume concentration except for the case where a mass or weight is specially shown clearly.

In the exhaust gas, the main component is neon, the first rare gas is 1 to 10% with respect to a total amount, preferably 1 to 8%, and as the impurity in the exhaust gas, for example, CF₄, N₂, He and the like are cited. A CF₄ concentration in the exhaust gas is assumed to be in a range of 1 ppm to 500 ppm.

When the CF₄ concentration is the first threshold value (for example, 100 ppm) or more, the treatment selection section selects the first treatment. In the first treatment, the exhaust gas is discharged to outside the system by the release line.

When a constant amount (for example, 100 ppm) or more of CF₄ is introduced into the decomposing device, a part of CF₄ contained in the exhaust gas is not decomposed, and cannot be completely removed, but by adopting the configuration like this, complete removal can be performed by discharging the exhaust gas with a possibility of insufficient CF₄ removal, to outside the system in advance, whereby complete removal can be performed.

Further, in the case of a high concentration of CF₄, an amount of a decomposition byproduct which is generated in the decomposing device increases, a replacement frequency of a predetermined reaction agent (for example, a metal reaction agent, a gas absorption system reaction agent) is increased, and the problem that corrosion of piping, valves and the like advances occurs, so that these problems are reduced so that CF₄ of a concentration of the first threshold value or more is not introduced into the decomposing device. The value of the first threshold value may be set in accordance with the capability of the decomposing device.

When the CF₄ concentration is larger than the second threshold value (for example, 10 ppm) which is smaller than the first threshold value, and is less than the first threshold value, the second treatment is selected. The second treatment introduces exhaust gas into the decomposing device from the decomposition removal treatment line. In the decomposing device, CF₄ becomes a decomposition byproduct (F₂, other fluorine compounds) by, for example, UV laser light, excimer laser light or plasma decomposition, and the decomposition byproduct is removed by reaction with a predetermined reaction agent (for example, a metal reaction agent, a gas absorbing reaction agent).

When the CF₄ concentration is less than the second threshold value, the third treatment is selected, the third treatment bypasses the decomposing device, and the exhaust gas is directly introduced into the second impurity removing device at the subsequent stage.

When the impurity concentration measurement section measures concentrations of CF₄, N₂ and He in the exhaust gas,
(a) the He concentration is the third threshold value or more,
(b) either CF₄ or N₂ is the first threshold value (for example, an arbitrary numerical value between 80 ppm and 110 ppm, preferably 90 ppm to 100 ppm) or more, or
(c) when the He concentration is less than the third threshold value, either CF₄ or N₂ is from the second threshold value (for example, an arbitrary numerical value between 5 ppm and 15 ppm, preferably 8 ppm to 12 ppm) to the first threshold value, and a large/small relationship of concentration is N₂>(½)×CF₄, the treatment selection section selects the first treatment.

(d) when the He concentration is less than the third threshold value, and a concentration of N₂ or CF₄ is from the second threshold value to the first threshold value, and a large/small relationship of the concentration is N₂<(½)×CF₄, the treatment selection section selects the second treatment.

(e) when the He concentration is less than the third threshold value, and the concentration of N2 or CF₄ is less than the second threshold value, control of the treatment selection section selecting the third treatment may be performed.

In the above described invention, “the third threshold value” is, for example, an arbitrary value between 0.5% and 1.5%, preferably an arbitrary numerical value between 0.8% and 1.2%, and more preferably 1.0%.

As the impurities in the exhaust gas, the concentrations of CF₄, N₂ and He may be measured. The concentrations of CF₄ and N₂ in the exhaust gas are assumed to be in a range of 1 ppm to 500 ppm, and the He concentration is assumed to be in a range of 0.01 to 5.0%.

When the CF₄ or N₂ concentration is 100 ppm or more, for example, or the He concentration is 1% or more, for example, laser intensity is reduced, so that when the CF₄ or N₂ concentration is the first threshold value (for example, 100 ppm) or more, or the He concentration is the third threshold value (for example, 1%) or more, the treatment selection section selects the first treatment, and the first treatment discharges the exhaust gas to outside the system by the release line.

Even when the He concentration is less than the third threshold value, and the CF₄ and N₂ concentrations are larger than the second threshold value (for example, 10 ppm) which is smaller than the first threshold value, and are less than the first threshold value, when the N₂ concentration is twice as high as or higher than the CF₄ concentration, as for the amount of ion that is generated in the decomposition process of the decomposing device, the nitrogen ion amount is advantageous over the carbon ion amount. In this case, nitrogen ion that is decomposed and generated in the decomposing device reacts with oxygen or oxygen ion contained in the exhaust gas more preferentially than carbon ion, and generates nitrogen oxide. Consequently, when the N₂ concentration becomes twice as high as or higher than the CF₄ concentration, the treatment selection section selects the first treatment, and in the first treatment, the exhaust gas is discharged to outside the system by the release line.

When the He concentration is less than the third threshold value, the CF₄ and N₂ concentrations are from the second threshold value to the first threshold value, and the N₂ concentration is less than twice as high as the CF₄ concentration, decomposition is enabled by the decomposing device, and the nitrogen oxide generation amount by the decomposition is also small, so that the second treatment is selected. In the second treatment, the exhaust gas is introduced into the decomposing device through the decomposition removal treatment line.

When the He concentration is less than the third threshold value, and the CF₄ and N₂ concentrations are less than the second threshold value, the third treatment is selected. In the third treatment, the decomposing device is bypassed, and the exhaust gas is directly introduced into the second impurity removing device at the subsequent stage.

In the above described invention, the fluorine compound removal section, the impurity concentration measurement section, the buffer tank, the decomposing device, and the decomposition byproduct removal section may be disposed in this order in the decomposition removal treatment line.

In the above described invention, a first recycle line that returns the first purified gas which is treated in the first impurity removing device to the oscillation chamber as the recycle gas may be included.

In the above described invention, a gas treatment line for feeding the first purified gas which is treated in the first impurity removing device to the process at the subsequent stage for further treatment may be included.

In the above described invention, the excimer laser oscillation device may further include a second impurity removing device that further removes impurities from the first purified gas treated in the first impurity removing device inside the system of the excimer laser oscillation device.

In the above described invention, a second recycle line that returns the second purified gas which is treated in the second impurity removing device to the oscillation chamber as the recycle gas may be further included. As another embodiment, the second impurity removing device may be disposed outside the system of the excimer laser oscillation device. Alternatively, the second impurity removing device may be disposed inside the system, and the third impurity removing device including the recycle function may be further included outside the system, aside from the second impurity removing device.

In the above described invention, the excimer laser oscillation device, the first impurity removing device and/or the second impurity removing device may include a booster (for example, a compressor) that boosts the first purified gas to a predetermined pressure (a pressure that is the same as or higher than the supply pressure of the material gas, or a pressure that is the same as or higher than a pressure in the oscillation buffer).

A recycle line that feeds the first purified gas that reaches the predetermined pressure by the booster to the oscillation chamber may be included.

In the above described invention, the second impurity removing device may have

a first removal section (for example, de-oxygen reaction means) that removes a first impurity (for example, oxygen) from the first purified gas, and

a second removal section (for example, a getter) that removes a second impurity from the first purified gas that passes through the first removal section.

As another embodiment, the second impurity removing device (may include components described later) may be disposed in the system of the excimer laser oscillation device, in place of the above described first impurity removing device.

The booster, the first removal section and the second removal section may be disposed in the common gas treatment line.

The first removal section may remove the first impurity from the first purified gas that has the pressure raised to a predetermined pressure by the booster.

The second purified gas (recycle gas) that passes through the second removal section may be fed to the oscillation chamber through the second recycle line.

In the second impurity removing device,

a gas flow rate adjustment section that adjusts the flow rate of the exhaust gas or the gas flow meter that measures a flow rate of the purified gas may be disposed in the gas treatment line upstream of the first removal section at a downstream side of the booster.

In the second impurity removing device,

a gas pressure adjustment section that adjusts the pressure of the exhaust gas or the gas pressure gauge that measures the gas pressure may be disposed in the gas treatment line upstream of the first removal section at the downstream side of the booster.

The second impurity removing device may further have

a purified gas buffer tank that stores the second purified gas (for example, main component neon gas containing the first rare gas) that passes through the second removal section.

The second impurity removing device includes argon (Ar) as the first rare gas, xenon (Xe) as the second rare gas in the first purified gas, when the laser gas which is the raw material is Ar/Xe-containing neon gas, and

may further have a xenon removal section that removes the xenon from the first purified gas, between the first removal section and the second removal section. As for the xenon removal section, a configuration in which active carbon or an adsorbent of zeolite is filled is cited as an example.

The second impurity removing device includes argon (Ar) as the first rare gas and xenon (Xe) as the second rare gas in the first purified gas when the laser gas which is the raw material is Ar/Xe-containing neon gas, and

may further have an introduction line for introducing auxiliary xenon-containing neon gas into the purified gas buffer tank or the piping of the gas treatment line in which the second purified gas flows. The introduction line may be connected to the purified gas buffer tank or the gas treatment line upstream or downstream of the purified gas buffer tank. The second purified gas and the xenon-containing neon gas may be mixed in the purified gas buffer tank or the piping of the gas treatment line. The auxiliary xenon-containing neon gas is stored in the system or an auxiliary tank outside the system, and the auxiliary tank may be connected to the introduction line.

In the introduction line, the gas flow rate adjustment section or the gas flow meter, or the gas pressure adjustment section or the gas pressure gauge may be disposed. The pressure adjustment section may adjust the pressure of the auxiliary xenon-containing neon gas to the predetermined pressure (for example, the first pressure). “The first pressure” is the pressure of the laser gas which is supplied to the oscillation chamber or a pressure higher than that pressure.

The second impurity removing device may further have a recycle tank that stores the second purified gas and the xenon-containing neon gas. The introduction line may be connected to the recycle tank. The second purified gas and the auxiliary xenon-containing neon gas may be mixed in the recycle tank.

In the second impurity removing device,

the gas flow rate adjustment section that adjusts the flow rate of the second purified gas or the gas flow meter that measures the flow rate of the second purified gas may be disposed in the gas treatment line at the downstream side from the second removal section. The gas flow rate adjustment section or the gas flow meter may be disposed at the downstream side of the purified gas buffer tank or at the downstream side of the recycle tank.

In the second impurity removing device,

the gas pressure adjustment section that adjusts the pressure of the second purified gas or the gas pressure gauge that measures the gas pressure may be disposed in the gas treatment line at the downstream side of the second removal section. The gas pressure adjustment section or the gas pressure gauge may be disposed at the downstream side of the purified gas buffer tank or at the downstream side of the recycle tank.

In the second impurity removing device,

the gas pressure adjustment section that adjusts the pressure of the second purified gas or the gas pressure gauge that measures the gas pressure, and the gas flow rate adjustment section that adjusts the flow rate of the second purified gas or the gas flow meter that measures the flow rate of the second purified gas may be disposed in this order in the gas treatment line at the downstream side from the second removal section. The gas flow rate adjustment section that adjusts the flow rate of the second purified gas or the gas flow meter that measures the flow rate of the second purified gas, and the gas pressure adjustment section that adjusts the pressure of the second purified gas or the gas pressure gauge that measures the gas pressure may be disposed in this order, in the gas treatment line at the downstream side from the second removal section.

The second impurity removing device may have a configuration in which two xenon removal sections are disposed in parallel, and adsorption treatment is performed in one of them, whereas in the other one, regeneration treatment is performed.

The second impurity removing device may further have the temperature adjustment section that adjusts the temperature of the first purified gas. As the temperature adjustment section, for example, the heat exchanger is cited. The temperature adjustment section is disposed at the downstream side from the booster, and may be preferably disposed between the booster and a predetermined flow rate adjustment section or the gas flow meter that is downstream side from the booster, or between the booster and the gas pressure adjustment section or the gas pressure gauge.

According to the configuration, the temperature of the first purified gas can be adjusted to the predetermined temperature, and the temperature (for example, 60 to 80° C.) of the first purified gas that is raised as the pressure is increased by the booster can be adjusted to the predetermined temperature (15 to 35° C., for example). Further, the temperature of the first purified gas can be adjusted to be within the temperature range which is suitable for removing action in the first and second removal sections at the subsequent stage.

A first bypass line to the first removal section may be included.

A second bypass line to the second removal section may be included.

A third bypass line to the xenon removal section may be included.

In the first to the third bypass lines, the gate valves are respectively disposed. The gate valves are configured to be opened at the time of bypass treatment.

The first removal section may have the gate valve at least at the upstream side thereof.

The second removal section may have the gate valve at least at the upstream side thereof.

The xenon removal section may have the gate valve at least at the upstream side thereof.

### Method

A recycle gas generation method that is executed in a system (in a casing) of the excimer laser oscillation device of the present invention is a recycle gas generation method,

wherein a first impurity removing step of removing impurities in the exhaust gas discharged from the oscillation chamber is executed in the system of the excimer laser oscillation device.

The first impurity removing step may have the fluorine compound removing step of removing a fluorine compound which is a part of impurities.

The first impurity removing step may have

a decomposing step of decomposing a carbon fluoride that is a part of the impurities to a decomposition byproduct, and

a decomposition byproduct removing step section that causes the decomposition byproduct generated in the decomposing step to react with the predetermined reaction agent to remove the decomposition byproduct from the exhaust gas.

The first impurity removing step may have an impurity concentration measuring step of measuring an impurity concentration in the exhaust gas discharged from the oscillation chamber.

In the recycle gas generation method,

a second impurity removing step of further removing impurities from the first purified gas treated in the first impurity removing step may be further executed in the system of the excimer laser oscillation device.

The second impurity removing step may have a pressure increasing step of increasing a pressure of the first purified gas to a predetermined pressure.

The second impurity removing step may have a first removing step of removing a first impurity from the first purified gas, and

a second removing step of removing a second impurity from the first purified gas after the first removing step.

The second impurity removing step may have

a xenon-containing recycle gas generation step of mixing the second purified gas and auxiliary xenon-containing neon gas after the second removing step, when argon (Ar) as first rare gas and xenon (Xe) as second rare gas are contained in the first purified gas.

The second impurity removing step may have

a heat exchange step of lowering a temperature of the first purified gas after the pressure increasing step.

### BRIEF DESCRIPTION OF DRAWINGS

FIG. 1A is a diagram illustrating a configuration example of an excimer laser oscillation device of Embodiment 1.

FIG. 1B is a diagram illustrating a configuration example of the excimer laser oscillation device of Embodiment 1.

FIG. 2A is a diagram illustrating a configuration example of an excimer laser oscillation device of Embodiment 2.

FIG. 2B is a diagram illustrating a configuration example of the excimer laser oscillation device of Embodiment 2.

FIG. 3 is a diagram illustrating a configuration example of an excimer laser oscillation device of Embodiment 3.

FIG. 4 is a diagram illustrating a configuration example of an excimer laser oscillation device of Embodiment 4.

FIG. 5 is a diagram illustrating a configuration example of an excimer laser oscillation device of Embodiment 5.

FIG. 6 is a diagram illustrating a configuration example of an excimer laser oscillation device of Embodiment 6.

### DESCRIPTION OF EMBODIMENTS

### Embodiment 1

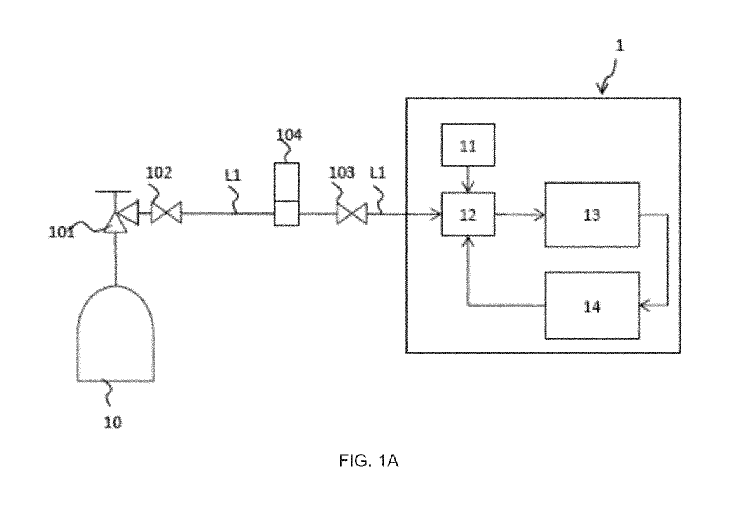

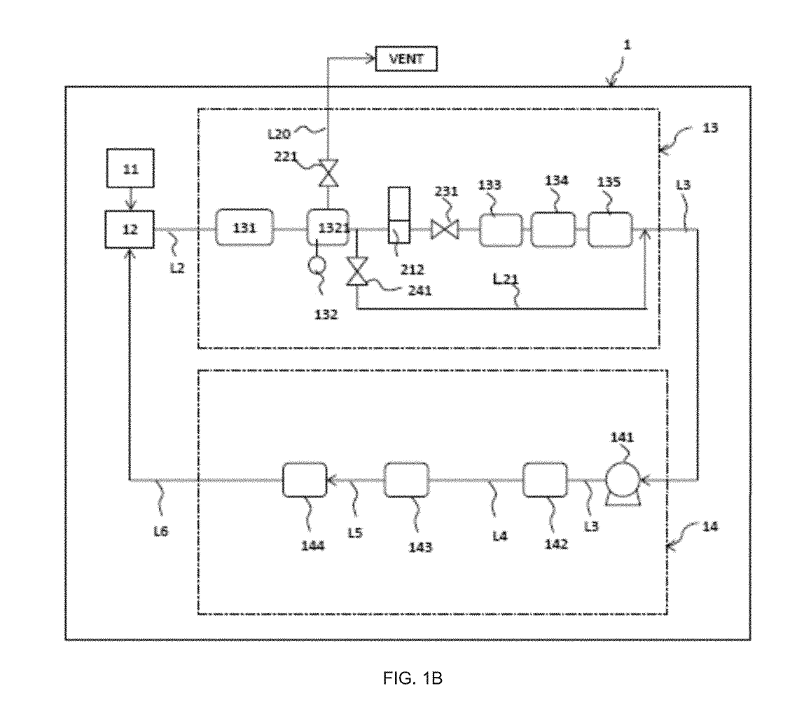

An excimer laser oscillation device 1 of Embodiment 1 will be described with use of FIGS. 1A and 1B.

The excimer laser oscillation device is, for example, krypton fluorine (KrF) excimer laser oscillation device, an argon fluorine (ArF) excimer laser oscillation device, an argon/xenon fluorine (Ar/Xe.F) excimer laser oscillation device.

The excimer laser oscillation device 1 of Embodiment 1 includes an oscillation chamber 12 in which laser gas having halogen gas (for example, fluorine), rare gas (for example, krypton, argon and xenon), and buffer gas (for example, neon, helium and chlorine) is filled inside, a first impurity removing device 13 that removes impurities in exhaust gas that is discharged from the oscillation chamber 12, and a second impurity removing device 14 that removes impurities from the first purified gas that is fed from the first impurity removing device 13, inside a system of the excimer laser oscillation device 1.

The oscillation chamber 12 is filled with a predetermined amount of laser gas having a predetermined pressure. In this state, a high voltage pulse generator 11 applies high-voltage pulse discharge to at least a pair of electrodes with respect to laser gas (excitation gas) in the oscillation chamber 12, whereby excimer in an excited state is generated, and causes induced emission, and light is obtained. Light emitted from the oscillation chamber 12 is adjusted to a specific wavelength width by a band narrowing module not illustrated. The light which is returned from the band narrowing module to the oscillation chamber 12 is amplified by passing between the above described pair of electrodes. The band narrowing module and an output mirror connect to each other on an optical path line so as to pass through the oscillation chamber 12, and every time light reciprocates between the band narrowing module and the output mirror, light is amplified by passing between the pair of electrodes. The light transmitting through the output mirror is outputted to an exposure device, for example, as output laser light. Here, a function of a resonator is realized by the band narrowing module and the output mirror, but the function of the resonator may be realized by other components.

Laser gas that is filled in the oscillation chamber 12 has excitation gas including, for example, neon gas or buffer gas such as helium (90 to 95%, for example), rare gas (Kr, Ar, Xe) (5 to 9%, for example), and halogen gas (F₂) (1 to 5%, for example). For example, as excitation gas, KrF, ArF, XeF, Ar/XeF and the like are cited.

In the present embodiment, it is main component buffer gas (neon, for example) including rare gas of same components as laser gas components (for example, krypton, argon, argon xenon) that is returned to the oscillation chamber 12 as recycle gas. Halogen gas-containing main component buffer gas and recycle gas are mixed, and thereafter, may be fed to the oscillation chamber 12.

The excimer laser oscillation device 1 may have a first laser gas supply line for feeding first laser gas to the oscillation chamber 12, a second laser gas supply line for feeding second laser gas, and a recycle gas line that feeds recycle gas.

The first laser gas may be halogen gas-containing main component buffer gas or rare gas and halogen gas-containing main component buffer gas.

The second laser gas may be halogen gas-containing main component buffer gas or rare gas and halogen gas-containing main component buffer gas.

In each of the first laser gas supply line, and the second laser gas supply line, a control valve, a gas flow meter, a gas flow rate adjustment section, a pressure gauge, a pressure adjustment section (a pressure reduction valve, for example) and the like are disposed, the first laser gas supply line and the second laser gas supply line are controlled by a control device when laser gas is supplied to the oscillation chamber 12, and laser gas at a predetermined pressure and a predetermined flow rate is supplied to the oscillation chamber.

In FIG. 1A, the first laser gas is supplied at a predetermined pressure (a first pressure) to the excimer laser oscillation device 1 through a supply line L1 from a supply container 10. In the supply line L1, a supply valve 101, a gate valve 102 (may or may not be present), a gas flow rate adjustment section 104 and a supply gate valve 103 are disposed. The gas flow rate adjustment section 104 has a gas flow meter, and a gas flow rate adjustment valve, and adjusts a valve in accordance with a measurement value of the gas flow meter and controls a gas flow rate. Instead of the gas flow rate adjustment section 104, a gas flow meter, a pressure gauge, and a pressure reduction adjustment section may be disposed.

The control device of the excimer laser oscillation device 1 controls the supply valve 101 and/or the supply gate valve 103 to close when only recycle gas is supplied to the oscillation chamber 12, for example. “First pressure” is set in accordance with the specifications of the excimer laser oscillation device 1, and is 300 KPa to 700 KPa, for example.

Further, the second laser gas supply line (not illustrated) for supplying the second laser gas is provided to be connected to the supply line L1, the oscillation chamber 12 or recycle lines (L31, L6). In the second laser gas supply line (not illustrated), various valves and a gas flow rate adjustment section are disposed as in the first laser gas supply line.

When a pressure of the first laser gas in the supply container 10 is larger than a first pressure, the pressure of the first laser gas may be reduced to the first pressure by the gas pressure reduction valve (not illustrated) which is disposed at an upstream side or a downstream side of the gas flow rate adjustment section 104.

When a pressure of the second laser gas in the supply container not illustrated is larger than the first pressure, the pressure of the second laser gas may be reduced to the first pressure by a gas pressure reduction valve (not illustrated).

### First Impurity Removing Device

FIG. 1B illustrates configuration examples of the first impurity removing device 13 and the second impurity removing device 14.

The exhaust gas which is discharged from the oscillation chamber 12 is fed to the first impurity removing device 13 through the exhaust gas line L2. The exhaust gas is discharged by a second pressure that is from an atmospheric pressure to the above described first pressure inclusive. The second pressure is also set in accordance with the specifications of the excimer laser oscillation device 1. Note that a discharging pump (not illustrated) may be disposed in the exhaust gas line L2 and may be configured to execute (or promote) discharge of exhaust gas.

The “second pressure” is 50 to 100 KPa, for example. The exhaust gas which is discharged includes impurities. As the impurities, for example, a nitrogen, an oxygen, a carbon monoxide, a carbon dioxide, water, CF₄, He, CH₄ and the like are cited.

The control device of the excimer laser oscillation device 1 has a laser gas supply/discharge control section (not illustrated), and the laser gas supply/discharge control section controls the control valve, the gas flow meter, the gas flow rate adjustment section, the gas pressure reduction valve and the like, and discharges laser gas (exhaust gas) from the oscillation chamber 12 in accordance with a predetermined rule (for example, a regular timing based on the operation time), and supplies any one or two kinds or more of the first laser gas, the second laser gas and the recycle gas in amount corresponding to a discharged amount of the laser gas.

The exhaust gas line L2 is a decomposition removal treatment line in the first impurity removing device 13.

First, the exhaust gas is fed to a fluorine compound removal section 131, and a fluorine compound that is a part of impurities is removed.

Next, the exhaust gas is fed to a buffer space 1321 to be stored so that the exhaust gas is in a constant amount. The buffer space 1321 has a function of storing a predetermined amount of exhaust gas, and stably performing impurity measurement by an impurity concentration measurement section 132 described later.

The impurity concentration in the exhaust gas is measured by an impurity concentration measurement section 132 which is disposed inside the buffer space 1321. Here, a concentration of CH₄, for example, is measured as an impurity. As the impurity concentration measurement section 132, for example, gas chromatography, a heat conduction type concentration sensor, a semiconductor type concentration sensor and the like can be used.

A release line L20 for releasing the exhaust gas to outside air from the buffer space 1321 is provided. The release line L20 is configured by having, for example, piping, a vent device for discharging to outside air, and an automatic on-off valve 221.

A bypass line L21 branches from the decomposition removal treatment line L2 downstream of the buffer space 1321. The bypass line L21 is configured by having piping and an automatic on-off valve 241, for example.

The decomposition removal treatment line L2 is configured by having, for example, piping and the gas flow rate measurement section 212, and an automatic on-off valve 231. As the gas flow rate measurement section 212, a mass flow meter can be used. A replacement timing determination section (not illustrated) may calculate an amount of impurities, based on a measurement value of the gas flow rate measurement section 212 and a measurement value of the impurity concentration measurement section 132, and obtain a replacement timing of a predetermined reaction agent of a decomposition byproduct removal section 135. The obtained replacement timing may be outputted to an input/output interface and may be reported to an operator.

Further, in the decomposition removal treatment line L2, a buffer container 133 is disposed at a downstream side from the automatic on-off valve 231, and is configured to store a predetermined amount of exhaust gas in the buffer container 133. At a downstream side from the buffer container 133, a decomposing device 134 that decomposes a carbon fluoride (CF₄) which is a part of impurities to a decomposition byproduct is disposed. In the present embodiment, the decomposing device 134 is a device that irradiates the exhaust gas with excimer laser light.

A decomposition byproduct removal section 135 is disposed at a downstream side from the decomposing device 134. In the present embodiment, the decomposition byproduct is a fluorine compound, for example, and the decomposition byproduct generated in the decomposing device 134 is caused to react with a predetermined reaction agent (for example, a metallic reaction agent or a gas absorbing reaction agent) to be removed from the exhaust gas. The exhaust gas which passes thorough the decomposition byproduct removal section 135 is referred to as first purified gas. The first purified gas is fed to the second impurity removing device 14 by a gas treatment line L3.

Further, as another embodiment, the gas flow rate measurement section 212 may or may not be present.

Determination of treatment selection in the present embodiment is as follows.

The impurity concentration measurement section 132 measures the concentration of CF₄ in the exhaust gas. In this case, when the concentration of CF₄ is a first threshold value (for example, 100 ppm) or more, a treatment selection section (not illustrated) selects first treatment. When the concentration of CF₄ is larger than a second threshold value (for example, 10 ppm) that is smaller than the first threshold value, and is less than the first threshold value, the treatment selection section selects second treatment, and when the concentration of CF₄ is less than the second threshold value, the treatment selection section selects third treatment.

Further, as another embodiment, the impurity concentration measurement section 132 measures concentrations of CF₄, N₂ and He in the exhaust gas.

In this case, when

(a) an He concentration is the third threshold value (for example, 1.0%) or more,

(b) either CF₄ or N₂ is the first threshold value (100 ppm, for example) or more, or

(c) the He concentration is less than the third threshold value, either CF₄ or N₂ is from the second threshold value (10 ppm, for example) to the first threshold value, and a large/small relationship of concentration is N₂>(½)×CF₄, the treatment selection section selects the first treatment.

(d) When the He concentration is less than the third threshold value, and a concentration of N₂ or CF₄ is from the second threshold value to the first threshold value, and the large/small relationship of the concentration is N₂<(½)×CF₄, the treatment selection section selects the second treatment.

(e) When the He concentration is less than the third threshold value, and the concentration of N₂ or CF₄ is less than the second threshold value, the treatment selection section selects the third treatment.

Note that a gas absorbing reaction agent also can be used instead, without being limited to the above described metal reaction agent.

The control device, the treatment selection section, the control section for various valves, and the replacement timing determination section each may be configured by having hardware such as a CPU (or an MPU), a circuit, firmware, a memory storing a software program and the like, and to operate by cooperation with software.

### Second Impurity Removing Device

The second impurity removing device 14 removes the first and second impurities from the first purified gas which is fed by the gas treatment line L3, and obtains the second purified gas. The gas treatment line L3 is configured by having, for example, piping and one or more automatic on-off valves.

In the gas treatment line L3, a compressor 141, a first removal section 142, a second removal section 143, and a purified gas buffer tank 144 are disposed in this order. The gas which passes through the second removal section 143 is referred to as the second purified gas (also referred to as recycle gas).

Further, as another embodiment, a heat exchanger, an adjustment section that adjusts a flow rate of the first purified gas, a flow meter that measures the flow rate of the first purified gas, and the pressure adjustment section that adjusts pressure of the first purified gas may be provided at an upstream side from the first removal section 142. The heat exchanger lowers the temperature of the first purified gas to a predetermined temperature. The gas temperature (60 to 80° C., for example) which rises as the pressure is increased by the compressor 141 can be lowered to a predetermined temperature (15 to 35° C., for example), and the gas temperature is lowered to a temperature range suitable for removal action in various removal sections at the subsequent stage, for example.

Further, as another embodiment, at a downstream side from the second removal section 142 or at a downstream side of the purified gas buffer tank 144, an adjustment section that adjusts a flow rate of the second purified gas, a flow meter that measures the flow rate of the second purified gas, and a pressure adjustment section that adjusts a pressure of the second purified gas may be provided.

The compressor 141 increases the pressure of the first exhaust gas to a third pressure. The third pressure is a pressure that is higher than the first pressure by about 50 KPa to 150 KPa, for example. A pressure control section (not illustrated) controls the pressure of the first purified gas based on the measurement value of a pressure gauge which is incorporated in the compressor 141, or a pressure gauge which is disposed downstream from the compressor 141.

The first removal section 142 is a deoxygenating device filled with a manganese oxide reaction agent or a copper oxide reaction agent, which removes oxygen from the first purified gas. As the manganese oxide reaction agent, there are cited a reaction agent such as a manganese monoxide MnO, a reaction agent such as a manganese dioxide MnO₂, and a manganese oxide reaction agent with an adsorbent as a base. As the copper oxide reaction agent, for example, a reaction agent such as a copper oxide CuO, and a copper oxide reaction agent with the adsorbent as a base are cited.

The purified gas which passes through the first removal section 142 is fed to the second removal section 143 through a pipe L4.

The second impurity is a component from which an impurity which is contained in a largest amount in the exhaust gas components, and, for example, a nitrogen, a carbon monoxide, a carbon dioxide, water, CF₄, CH₄, He and the like are cited. CF₄ may be removed by the first impurity removing device (partial removal, complete removal), or CF₄ may bypass the first impurity removing device and may be fed to the second impurity removing device.

The second removal section 143 is a getter that removes impurities (for example, a nitrogen, a carbon monoxide, a carbon dioxide, water, CH₄) other than oxygen, and is filled with a chemical adsorbent.

The second purified gas which passes through the second removal section 143 is gas (rare gas-containing main component buffer gas) from which an oxygen and impurities other than an oxygen are removed. The second purified gas is fed to the purified gas buffer tank 144 through a pipe L5.

The second purified gas in the purified gas buffer tank 144 is fed to the oscillation chamber 12 as recycle gas through a recycle line L6. In the recycle line L6, one kind or more of, for example, an automatic on-off valve that opens at a time of supplying recycle gas, an adjustment section that adjusts a flow rate of recycle gas, a flow meter that measures the flow rate of the recycle gas, and a pressure adjustment section that adjusts a pressure of the recycle gas are provided, and one kind or more of them may be configured to be controlled by a laser gas supply/discharge control section, and supply the recycle gas to the oscillation chamber 12.

### Embodiment 2

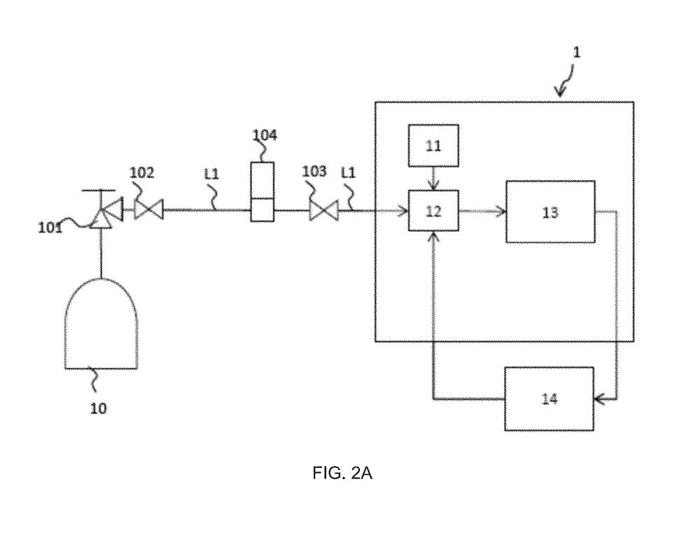

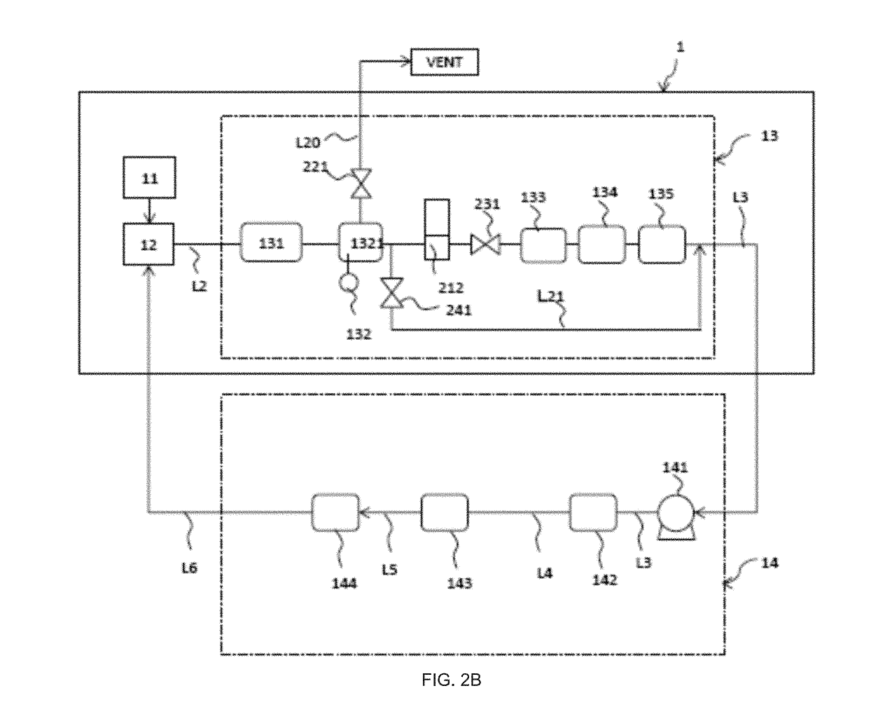

The excimer laser oscillation device 1 of Embodiment 2 will be described with use of FIGS. 2A and 2B. Explanation of components similar to the components in Embodiment 1 may be omitted or simplified. As illustrated in FIG. 2A, the excimer laser oscillation device 1 of Embodiment 2 is configured such that the excimer laser oscillation device 1 includes the first impurity removing device 13 in a system thereof, and the second impurity removing device 14 is disposed outside the system thereof.

As illustrated in FIG. 2B, the second impurity removing device 14 (the compressor 141, the first removal section 142, the second removal section 143, the purified gas buffer tank 144) is disposed outside the system of the excimer laser oscillation device 1.

### Embodiment 3

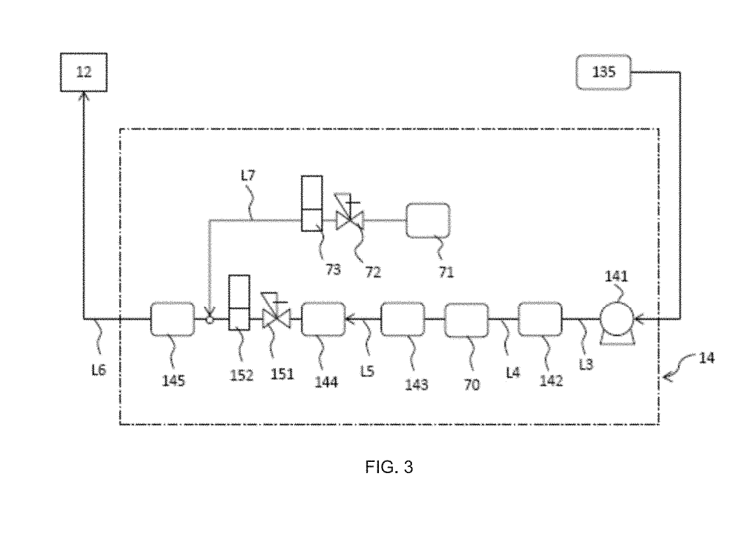

An excimer laser oscillation device of Embodiment 3 will be described with use of FIG. 3. Explanation of components similar to the components in Embodiments 1 and 2 may be omitted or simplified. A point different from A point different from Embodiments 1 and 2 is that in the configuration of the second impurity removing device 14, a xenon removal section 70 and an auxiliary xenon gas supply function are included. The second impurity is more easily removed in the second removal section 143 when xenon in the exhaust gas is removed for the components of the laser gas. That is, the second impurity removing device 14 may be disposed either in the system or outside the system of the excimer laser oscillation device.

The xenon removal section 70 is disposed at the subsequent stage of the first removal section 142, and xenon is removed here. The xenon removal section 70 is a de-xenon device filled with active carbon. The purified gas which passes through the xenon removal section 70 is fed to the second removal section 143.

At a downstream side of the purified gas buffer tank 144, a pressure reduction valve 151 and a gas flow rate adjustment section 152 are disposed. The pressure control section (not illustrated) controls the pressure reduction valve 151 and controls the pressure of the second purified gas, based on a measurement value of a pressure gauge disposed at a downstream side of the pipe L5 or a pressure gauge incorporated in the pressure reduction valve 151. The second purified gas of the purified gas buffer tank 144 is gas of a third pressure, and therefore is decompressed to a same pressure (the first pressure) as the laser gas in the oscillation chamber 12.

The purified gas flow rate adjustment section 152 has a gas flow meter and a gas flow rate adjustment valve, and the purified gas control section (not illustrated) adjusts the gas flow rate adjustment valve in accordance with a measurement value of the gas flow meter, and controls the flow rate of the second purified gas. Thereby, a supply amount of the second purified gas that is fed to the oscillation chamber 12 can be controlled to be constant. The purified gas flow rate adjustment section 152 may be only the gas flow meter. Disposition of the purified gas flow rate adjustment section 152 or the gas flow meter, and the pressure reduction valve 151 may be opposite to each other.

At a downstream side of the purified gas flow rate adjustment section 152, an auxiliary rare gas introduction line L7 that joins the pipe L5 is provided. In the auxiliary rare gas introduction line L7, an auxiliary container 71 in which buffer gas (for example, neon) and auxiliary rare gas of xenon are filled, a supply valve (not illustrated), an auxiliary rare gas pressure reduction valve (corresponding to an auxiliary rare gas pressure adjustment section) 72, and an auxiliary rare gas flow rate adjustment section 73 are disposed in this order.

The pressure control section (not illustrated) controls the auxiliary rare gas pressure reduction valve 72 based on a measurement value of a pressure gauge that is disposed at a downstream side of the auxiliary rare gas introduction line L7, and controls a pressure of the auxiliary rare gas. When the pressure of the auxiliary rare gas in the auxiliary container 71 is larger than the first pressure, the pressure of the auxiliary rare gas is reduced to be the first pressure.

The auxiliary rare gas flow rate adjustment section 73 has a gas flow meter and a gas flow rate adjustment valve, and the purified gas control section (not illustrated) adjusts the gas flow rate adjustment valve in accordance with the measurement value of the gas flow meter, and controls the flow rate of the auxiliary rare gas. The purified gas control section controls the flow rate of the auxiliary rare gas and the flow rate of the second purified gas so as to obtain xenon-containing gas (main component neon) with same loadings as loadings of the laser gas (for example, argon, xenon, neon).

In the present embodiment, in the pipe L5, a recycle gas tank 145 that stores recycle gas composed of the second purified gas and the auxiliary rare gas is disposed. Automatic on-off valves may be provided at an inlet side and an outlet side of the recycle gas tank 145. The second purified gas and the auxiliary rare gas are mixed in the recycle gas tank 145 and are stable at a constant concentration.

The recycle gas in the recycle gas tank 145 is fed to the oscillation chamber 12 through the recycle line L6. In the recycle line L6, for example, one kind or more of, for example, an automatic on-off valve that opens at the time of supplying recycle gas, an adjustment section that adjusts the flow rate of recycle gas, a flow meter that measures the flow rate of the recycle gas, and a pressure adjustment section that adjusts the pressure of the recycle gas are provided, one kind or more of them may be configured to be controlled by the laser gas supply/discharge control section, and to supply the recycle gas to the oscillation chamber 12.

### Embodiment 4

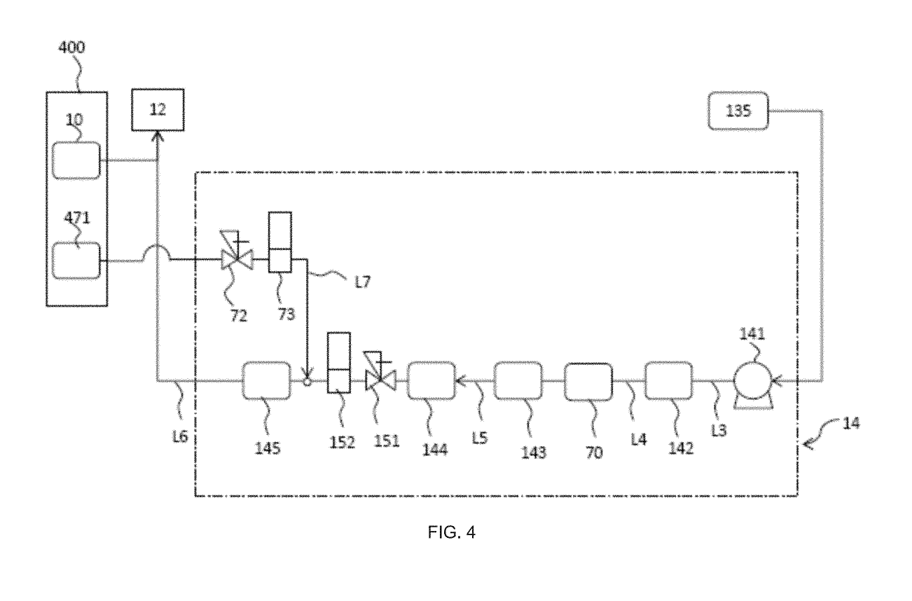

An excimer laser oscillation device of Embodiment 4 will be described with use of FIG. 4. Explanation of similar components to the components in Embodiment 3 may be omitted or simplified. A point different from Embodiment 3 is that an auxiliary container 471 filled with buffer gas (for example, neon) and auxiliary rare gas of xenon is housed in a laser gas tank cabinet 400. In the laser gas tank cabinet 400, the first laser gas tank 10 is also housed. Note that the second impurity removing device 14 may be disposed either in the system or outside the system of the excimer laser oscillation device.

### Embodiment 5

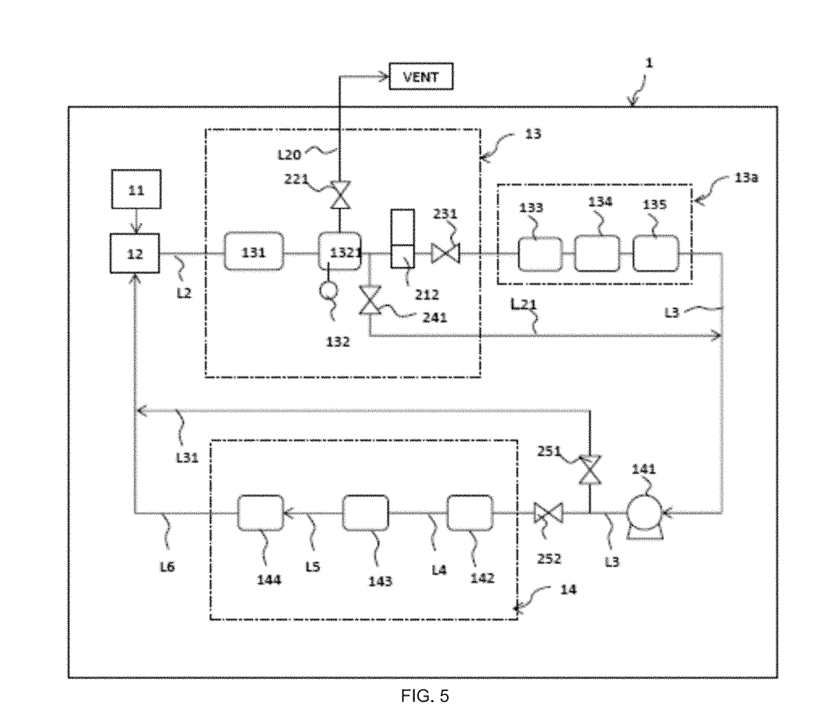

The excimer laser oscillation device 1 of Embodiment 5 will be described with use of FIG. 5. Explanation of similar components to the components in Embodiment 1 may be omitted or simplified. A point different from Embodiment 1 is that the first impurity removing device 13 has the fluorine compound removal section 131, the impurity concentration measurement section 132, the buffer space 1321, the gas flow rate measurement section 212 and the automatic on-off valve 231.

Note that the first impurity removing device 13 may be configured by having only the fluorine compound removal section 131, or may be configured by having only the impurity concentration measurement section 132.

As a third impurity removing device 13a, the buffer container 133, the decomposing device 134, and the decomposition byproduct removal section 135 may or not may be provided.

The compressor 141 is disposed in the gas treatment line L3 of the first purified gas, and an automatic on-off valve 252, and a branch line L31 that branches from the gas treatment line L3 between the compressor 141 and the automatic on-off valve 252 and feeds gas to the oscillation chamber 12 are provided downstream of the compressor 141. Note that a buffer tank (not illustrated) may be disposed at an upstream side of the compressor 141, and may be configured to store a predetermined amount of purified gas.

Based on the result of the impurity concentration measurement section 132, the purified gas which passes thorough the bypass line L21 or the first purified gas which passes through the third impurity removing device 13a is increased in pressure, and can be fed to the oscillation chamber 21. At this time, the automatic on-off valve 252 is closed, and an automatic on-off valve 251 which is disposed in the branch line L31 is opened. A heat exchanger may be disposed in the gas treatment line L3 or the branch line L31, and the temperature of the first purified gas may be reduced to a predetermined temperature.

A purified gas buffer tank may be disposed in the branch line L31. The purified gas is fed to the oscillation chamber 12 as recycle gas through the branch line L31. In the branch line L31, for example, one kind or more of an automatic on-off valve that opens at a time of supplying gas, an adjustment section that adjusts a gas flow rate, a flow meter that measures the flow rate of gas, and a pressure adjustment section that adjusts a pressure of gas are provided, and one kind or more of them may be configured to be controlled by a laser gas supply/discharge control section, and supply gas to the oscillation chamber 12.

Further, as another embodiment, another branch line is disposed at an upstream side from the compressor 141 in the gas treatment line L3, the purified gas that passes through a bypass line L21 from the other branch line or the first purified gas that passes through the third impurity removing device 13a can be fed to the oscillation chamber 21. In the other branch line, the purified gas buffer tank may be disposed. In the other branch line, for example, one kind or more of an automatic on-off valve that opens at a time of supplying gas, an adjustment section that adjusts a gas flow rate, a flow meter that measures a flow rate of gas, and a pressure adjustment section that adjusts the pressure of gas are provided, and one or more of them may be configured to be controlled by the laser gas supply/discharge control section, and supply the gas to the oscillation chamber 12.

### Embodiment 6

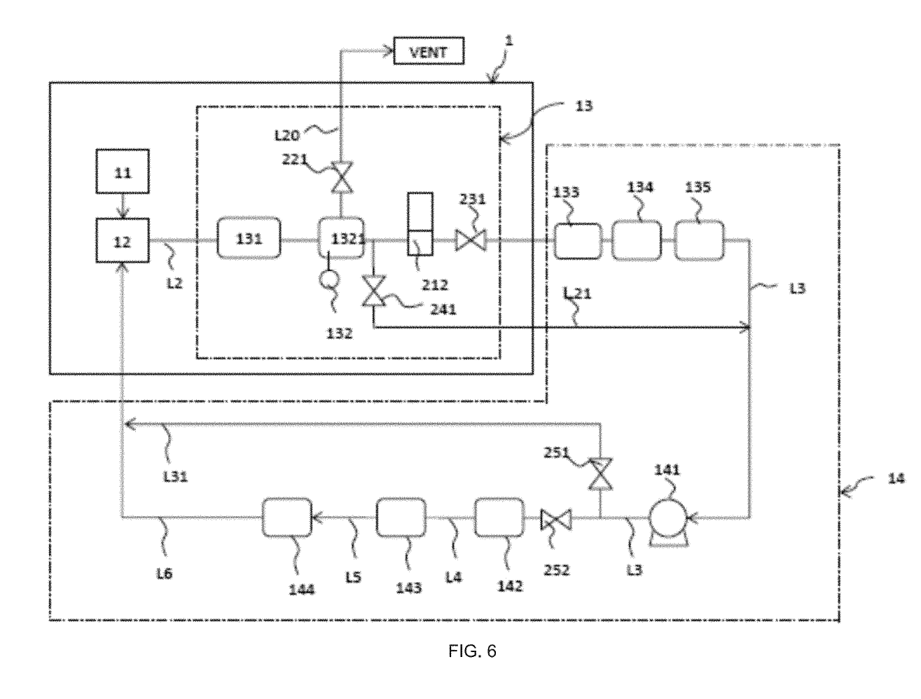

The excimer laser oscillation device 1 of Embodiment 6 will be described with use of FIG. 6. Explanation of similar components to the components in Embodiment 5 may be omitted or simplified. A point different from Embodiment 5 is that the third impurity removing device 13a is included in the second impurity removing device 14, and is disposed outside the system of the excimer laser oscillation device 1.

### Another Embodiment

In the above described Embodiments 1 to 6, the release line L20 and the bypass line L21 may or may not be present.

In the above described Embodiments 1 to 6, the first impurity removing device 13 may or may not be present.

In the above described Embodiments 1 to 6, the second impurity removing device 14 may or may not be present.

In the above described Embodiments 1 to 6, the bypass line L21 may be configured to feed the exhaust gas to the oscillation chamber 12 instead of being configured to feed the exhaust gas to the process at the subsequent stage. In such a case, the buffer tank may be disposed in the bypass line L21. The purified gas is fed to the oscillation chamber 12 as the recycle gas through the branch line L31. In the bypass line L21, for example, one kind or more of an automatic on-off valve that opens at a time of supplying gas, an adjustment section that adjusts a gas flow rate, a flow meter that measures the flow rate of gas, and a pressure adjustment section that adjusts a pressure of gas, and one or more of them may be configured to be controlled by the laser gas supply/discharge control section, and supply gas to the oscillation chamber 12.

### Recycle Gas Generation Method

A recycle gas generation method that is executed in a system (in a casing) of the above described excimer laser oscillation device,

wherein a first impurity removing step of removing impurities in exhaust gas discharged from an oscillation chamber is executed in a system of the excimer laser oscillation device.

The first impurity removing step may have a fluorine compound removing step of removing a fluorine compound that is a part of the impurities.

The first impurity removing step may have

a decomposing step of decomposing a carbon fluoride that is a part of impurities to a decomposition byproduct, and

a decomposition byproduct removing step of causing the decomposition byproduct generated in the decomposing step to react with a predetermined reaction agent and removing the decomposition byproduct from the exhaust gas.

The first impurity removing step may have an impurity concentration measuring step of measuring an impurity concentration in the exhaust gas which is discharged from the oscillation chamber.

In the recycle gas generation method,

a second impurity removing step of further removing impurities from the first purified gas which is treated in the first impurity removing step may be further executed in the system of the excimer laser oscillation device.

The second impurity removing step may have a pressure increasing step of increasing the pressure of the first purified gas to a predetermined pressure.

The second impurity removing step may have a first removing step of removing a first impurity from the first purified gas, and

a second removing step of removing a second impurity from the first purified gas after the first removing step.

The second impurity removing step may have

a xenon-containing recycle gas generation step of mixing the second purified gas and auxiliary xenon-containing neon gas after the second removing step, when argon (Ar) as first rare gas and xenon (Xe) as second rare gas are contained in the first purified gas.

The second impurity removing step may have

a heat exchange step of lowering a temperature of the first purified gas after the pressure increasing step.

### REFERENCE SIGNS LIST

1 Excimer laser oscillation device
11 High-voltage pulse generator
12 Oscillation chamber
13 First impurity removing device
131 Fluorine compound removal section
132 Impurity concentration measurement section
133 Buffer container
134 Decomposing device
135 Decomposition byproduct removal section
14 Second impurity removing device
141 Compressor
142 First removal section
143 Second removal section
144 Purified gas buffer tank

What is claimed is:

1. An excimer laser oscillation device including a gas recycle function, comprising:
an oscillation chamber in which laser gas having halogen gas, rare gas and buffer gas is filled inside; and
a first impurity removing device that removes impurities in exhaust gas that is discharged from the oscillation chamber, inside a system of the excimer laser oscillation device.

2. The excimer laser oscillation device according to claim 1, further comprising:
a treatment selection section that selects any one of first treatment that discharges exhaust gas to outside air, second treatment that executes impurity removing treatment, and third treatment that feeds the exhaust gas to a process at a subsequent stage, based on a result measured in the impurity concentration measurement section.

3. The excimer laser oscillation device according to claim 1, wherein the first impurity removing device includes an impurity concentration measurement section that measures an impurity concentration in exhaust gas that is discharged from the oscillation chamber.

4. The excimer laser oscillation device according to claim 1, wherein the first impurity removing device includes a decomposing device that decomposes a carbon fluoride that is a part of the impurities to a decomposition byproduct.

5. The excimer laser oscillation device according to claim 2, wherein the first impurity removing device includes a decomposition byproduct removal section that causes the decomposition byproduct generated in the decomposing device to react with a predetermined reaction agent and removes the decomposition byproduct from the exhaust gas.

6. The excimer laser oscillation device according to claim 1, wherein the first impurity removing device has a fluorine compound removal section that removes a fluorine compound that is a part of impurities.

7. The excimer laser oscillation device according to claim 6, further comprising:
a treatment selection section that selects any one of first treatment that discharges exhaust gas to outside air, second treatment that executes impurity removing treatment, and third treatment that feeds the exhaust gas to a process at a subsequent stage, based on a result measured in the impurity concentration measurement section.

8. The excimer laser oscillation device according to claim 6, wherein the first impurity removing device includes an impurity concentration measurement section that measures an impurity concentration in exhaust gas that is discharged from the oscillation chamber.

9. The excimer laser oscillation device according to claim 6, wherein the first impurity removing device includes a decomposing device that decomposes a carbon fluoride that is a part of the impurities to a decomposition byproduct.

10. The excimer laser oscillation device according to claim 9, further comprising:
a treatment selection section that selects any one of first treatment that discharges exhaust gas to outside air, second treatment that executes impurity removing treatment, and third treatment that feeds the exhaust gas to a process at a subsequent stage, based on a result measured in the impurity concentration measurement section.

11. The excimer laser oscillation device according to claim 9, wherein the first impurity removing device includes an impurity concentration measurement section that measures an impurity concentration in exhaust gas that is discharged from the oscillation chamber.

12. The excimer laser oscillation device according to claim 9, wherein the first impurity removing device includes a decomposition byproduct removal section that causes the decomposition byproduct generated in the decomposing device to react with a predetermined reaction agent and removes the decomposition byproduct from the exhaust gas.

13. The excimer laser oscillation device according to claim 12, further comprising:
a treatment selection section that selects any one of first treatment that discharges exhaust gas to outside air, second treatment that executes impurity removing treatment, and third treatment that feeds the exhaust gas to a process at a subsequent stage, based on a result measured in the impurity concentration measurement section.

14. The excimer laser oscillation device according to claim 12, wherein the first impurity removing device includes an impurity concentration measurement section that measures an impurity concentration in exhaust gas that is discharged from the oscillation chamber.

15. The excimer laser oscillation device according to claim 14, further comprising:
a treatment selection section that selects any one of first treatment that discharges exhaust gas to outside air, second treatment that executes impurity removing treatment, and third treatment that feeds the exhaust gas to a process at a subsequent stage, based on a result measured in the impurity concentration measurement section.

16. The excimer laser oscillation device according to claim 14, further comprising:
a second impurity removing device that further removes impurities from first purified gas that is treated in the first impurity removing device, inside the system of the excimer laser oscillation device.

17. The excimer laser oscillation device according to claim 1, further comprising:
a second impurity removing device that further removes impurities from first purified gas that is treated in the first impurity removing device, inside the system of the excimer laser oscillation device.

18. The excimer laser oscillation device according to claim 17, wherein the second impurity removing device further includes:
a first removal section that removes a first impurity from the first purified gas, and
a second removal section that removes a second impurity from the first purified gas that passes through the first removal section.

19. The excimer laser oscillation device according to claim 18, wherein the second impurity removing device further includes:
a xenon removal section that removes the xenon when an argon (Ar) is included as first rare gas, and xenon (Xe) is included as second rare gas in the first purified gas, and
an introduction line for introducing auxiliary xenon-containing neon gas to mix the auxiliary xenon-containing neon gas.

20. The excimer laser oscillation device according to claim 17, wherein the second impurity removing device further includes:
a xenon removal section that removes the xenon when an argon (Ar) is included as first rare gas, and xenon (Xe) is included as second rare gas in the first purified gas, and
an introduction line for introducing auxiliary xenon-containing neon gas to mix the auxiliary xenon-containing neon gas.
